(19) United States
(12) Patent Application Publication
(10) Pub. No.: US 2026/0331519 A1
(43) Pub. Date: Oct. 22, 2026

(54) POSITIVE ELECTRODE PLATE, METHOD OF PRODUCING THE SAME, AND METHOD OF PRODUCING SLURRY

(71) Applicant: Prime Planet Energy & Solutions, Inc., Tokyo (JP)

(72) Inventor: Atsushi KANDA, Hyogo (JP)

(21) Appl. No.: 19/634,068

(22) Filed: Mar. 31, 2026

(30) Foreign Application Priority Data
Apr. 2, 2025 (JP) 2025-061190

(51) Int. Cl. H01M 4/62; C08K 3/04; C08K 3/22; C09D 5/24; C09D 7/61; C09D 7/80; C09D 127/16; H01M 4/02; H01M 4/13; H01M 4/36

(52) U.S. Cl. CPC H01M 4/628; C09D 5/24; C09D 7/61; C09D 7/80; C09D 127/16; H01M 4/13; H01M 4/366; H01M 4/623; H01M 4/625; C08K 3/04; C08K 2003/2227; C08K 2201/001; H01M 2004/028

(57) ABSTRACT

A positive electrode plate comprises a metal layer, an active material layer containing a positive electrode active material, and a protective layer. The active material layer and the protective layer are formed on the metal layer and positioned adjacent to each other in a plan view of the positive electrode plate. The protective layer contains an inorganic oxide filler and polyvinylidene difluoride. The polyvinylidene difluoride is an unmodified homopolymer having a weight average molecular weight of 750,000 or more, and a content of the polyvinylidene difluoride in the protective layer is 13.5 weight % or more. The number of lumps in the protective layer is 0.50/cm² or less.

### CROSS REFERENCE TO RELATED APPLICATIONS

This nonprovisional application is based on Japanese Patent Application No. JP2025-061190 filed on Apr. 2, 2025, with the Japan Patent Office, the entire contents of which are hereby incorporated by reference.

### BACKGROUND OF THE INVENTION

### Field of the Invention

The present disclosure relates to a positive electrode plate, a method of producing the same, and a method of producing a slurry.

### Description of the Background Art

A positive electrode plate of a secondary battery has an active material layer on the surface of a metal layer. The positive electrode plate may further have a protective layer on the surface of the metal layer, adjacent to the active material layer. The protective layer is formed by applying a slurry containing an inorganic oxide, polyvinylidene difluoride (hereinafter also referred to as “PVdF”), and the like, to the metal layer (see, for example, Japanese Patent No. 5929897).

### SUMMARY OF THE INVENTION

The protective layer formed by application of the slurry to the metal layer can contain lumps. The lumps in the protective layer can impair the appearance of the positive electrode plate, and the lumps can also cause cutting failures when the positive electrode plate is cut by a laser into a certain shape.

The present disclosure aims at providing a positive electrode plate having a protective layer with reduced lumps, a method of producing the same, and a method of producing a slurry.

[1] A positive electrode plate comprising:
a metal layer;
an active material layer containing a positive electrode active material; and
a protective layer, wherein
the active material layer and the protective layer are formed on the metal layer and positioned adjacent to each other in a plan view of the positive electrode plate,
the protective layer contains an inorganic oxide filler and polyvinylidene difluoride,
the polyvinylidene difluoride is an unmodified homopolymer having a weight average molecular weight of 750,000 or more, and a content of the polyvinylidene difluoride in the protective layer is 13.5 weight % or more, and
the number of lumps in the protective layer is 0.50/cm² or less.

[2] The positive electrode plate according to [1], wherein a content of the inorganic oxide filler in the protective layer is from 40 to 99 weight %.

[3] The positive electrode plate according to [1] or [2], wherein a ratio of a content of the inorganic oxide filler and the content of the polyvinylidene difluoride ((the content of the inorganic oxide filler)/(the content of the polyvinylidene difluoride)) in the protective layer is 5.0 or more.

[4] The positive electrode plate according to any one of [1] to [3], wherein the protective layer further contains a conductive carbon material.

[5] The positive electrode plate according to any one of [1] to [4], wherein the inorganic oxide filler is alumina.

[6] A method of producing a slurry that is for forming a protective layer of a positive electrode plate, the method comprising:
mixing an inorganic oxide filler with a dispersion prepared by dispersing polyvinylidene difluoride in a solvent, wherein
the polyvinylidene difluoride is an unmodified homopolymer having a weight average molecular weight of 750,000 or more, and
a viscosity of the dispersion at 25 °C and at a shear rate of 100 s⁻¹ is from 0.96 to 1.45 Pa·s.

[7] The method of producing a slurry according to [6], further comprising preparing the dispersion by mixing the polyvinylidene difluoride with the solvent, where
the mixing according to [6] involves mixing the inorganic oxide filler with the dispersion obtained by the preparing.

[8] The method of producing a slurry according to [6] or [7], wherein the mixing according to [6] involves further adding a conductive carbon material and mixing together.

[9] The method of producing a slurry according to any one of [6] to [8], wherein an average viscosity of the slurry at 25 °C and at a shear rate of 0.1 to 10 s⁻¹ is from 1.0 to 13.0 Pa·s.

[10] The method of producing a slurry according to any one of [6] to [9], wherein the dispersion contains the polyvinylidene difluoride in a concentration of 4.7 to 5.3 wt %.

[11] A method of producing a positive electrode plate having a metal layer, an active material layer containing a positive electrode active material, and a protective layer, wherein
the active material layer and the protective layer are formed on the metal layer and positioned adjacent to each other in a plan view of the positive electrode plate, and
the method includes applying a slurry produced by the method of producing a slurry according to any one of [6] to [10] to the metal layer.

The foregoing and other objects, features, aspects and advantages of the present invention, when taken in conjunction with the accompanying drawings will become more apparent from the following detailed description of the present invention.

### BRIEF DESCRIPTION OF THE DRAWINGS

FIG. 1 is a schematic plan view illustrating an example of a positive electrode plate according to an embodiment.

FIG. 2 is an X-X′ cross-sectional view of FIG. 1.

### DESCRIPTION OF THE PREFERRED EMBODIMENTS

Herein, a numerical range such as “(from) m to n” includes the upper limit and the lower limit, unless otherwise specified. That is, “(from) m to n” means a numerical range of “not less than m and not more than n”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Positive Electrode Plate)

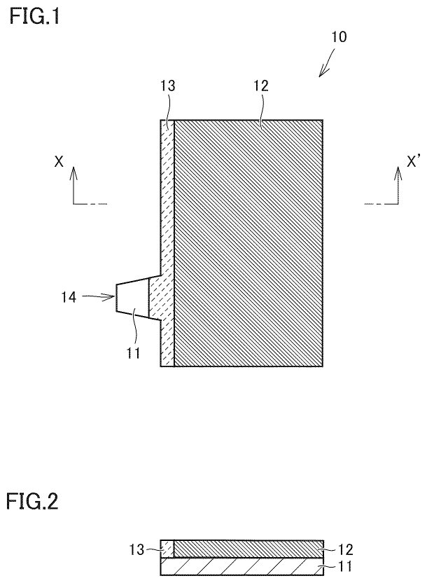

FIG. 1 is a schematic plan view illustrating an example of a positive electrode plate according to an embodiment. FIG. 2 is an X-X′ cross-sectional view of FIG. 1.

A positive electrode plate 10 according to the present embodiment (hereinafter also referred to as “the present positive electrode plate”) can be used in a non-aqueous electrolyte secondary battery (hereinafter also referred to as “a secondary battery”). The secondary battery may be a lithium-ion secondary battery that is charged and discharged through occlusion and release of lithium ions.

The present positive electrode plate 10 comprises a metal layer 11, an active material layer 12 containing a positive electrode active material, and a protective layer 13. Active material layer 12 and protective layer 13 are formed on metal layer 11 and positioned adjacent to each other in a plan view of the present positive electrode plate 10. Protective layer 13 contains an inorganic oxide filler and polyvinylidene difluoride (hereinafter also referred to as “the present PVdF”). The present PVdF is an unmodified homopolymer having a weight average molecular weight Mw of 750,000 or more. The content of the present PVdF in protective layer 13 is 13.5 weight % or more. The number of lumps in protective layer 13 is 0.50/cm² or less.

The present positive electrode plate 10 can have an electrode tab 14 that is to serve as a connecting portion connecting to an external terminal (a positive electrode terminal). Electrode tab 14 can be provided so as to protrude outwardly, in a plan view of the present positive electrode plate 10, from protective layer 13 provided to a side edge portion of the present positive electrode plate 10 (FIG. 1). Electrode tab 14 may include a region at which the surface of metal layer 11 is exposed, namely, a region at which neither active material layer 12 nor protective layer 13 is formed on the surface of metal layer 11, and it may include a part of a region at which protective layer 13 is formed on metal layer 11.

Active material layer 12 and protective layer 13 can be provided on one side or both sides of metal layer 11. At least part of active material layer 12 or the entirety thereof is in direct contact with metal layer 11. At least part of protective layer 13 or the entirety thereof is in direct contact with metal layer 11, and preferably, is formed on a region of metal layer 11 at which active material layer 12 is not formed. Since protective layer 13 is adjacent to active material layer 12 in a plan view of the present positive electrode plate 10, it does not cover the entirety of the surface of active material layer 12 opposite to metal layer 11 but it may cover part of that surface. In a plan view of the present positive electrode plate 10, a gap may be present between active material layer 12 and protective layer 13.

Metal layer 11 functions as a positive electrode current collector, and, for example, can be formed with the use of a metal foil sheet made of an aluminum material such as aluminum and aluminum alloy.

Active material layer 12 contains a positive electrode active material. Examples of the positive electrode active material include a lithium transition metal oxide of layered type, spinel type, or the like. The lithium transition metal oxide contains lithium and a transition metal. The transition metal is one, two, or more of Ni, Co, Mn, Fe, and Cr, for example, and it is preferably one, two, or more of Ni, Co, and Mn, more preferably Ni, Co, and Mn.

In addition to the positive electrode active material, active material layer 12 may contain either a binder or a conductive aid, or both.

Examples of the binder include one, two, or more selected from the group consisting of styrene-butadiene rubber (SBR), polyvinylidene difluoride (PVdF), and polytetrafluoroethylene (PTFE).

The conductive aid may be a carbon material. Examples of the carbon material include one or more selected from the group consisting of fibrous carbon, carbon black (such as acetylene black, Ketjenblack), coke, and activated carbon. The fibrous carbon may be carbon nanotubes (CNTs). The CNTs may be single-walled carbon nanotubes (SWCNTs), or may be multi-walled carbon nanotubes such as double-walled carbon nanotubes (DWCNTs).

Protective layer 13 is preferably provided along a side edge of active material layer 12, at a side edge portion of the present positive electrode plate 10 at which electrode tab 14 is provided. Usually, the electrical conductivity of protective layer 13 is less than that of metal layer 11 and that of active material layer 12. When protective layer 13 is provided adjacent to active material layer 12, it can inhibit a contact between metal layer 11 of the present positive electrode plate 10 and a negative electrode active material layer which can be caused by an incident such as breakage of a separator of an electrode assembly contained in the secondary battery, and can thereby reduce the occurrence of an internal short circuit of the secondary battery.

Protective layer 13 contains an inorganic oxide filler. The inorganic oxide filler can be a metal oxide filler. Examples of the inorganic oxide filler include one, two, or more selected from the group consisting of alumina (Al₂O₃), magnesia (MgO), silica (SiO₂), zirconia (ZrO₂), and titania (TiO₂). Preferably, the inorganic oxide filler is alumina.

The average particle size (D50) of the inorganic oxide filler may be, for example, from 0.1 to 2.0 μm, or from 0.3 to 1.5 μm, or from 0.5 to 1.0 μm. The average particle size (D50) refers to a particle size in volume-based particle size distribution at which cumulative frequency of particle sizes accumulated from the small size side reaches 50%. The volume-based particle size distribution can be measured with a laser-diffraction particle size distribution analyzer.

The BET specific surface area of the inorganic oxide filler may be, for example, from 1 to 10 m²/g, or from 2 to 8 m²/g, or from 3 to 6 m²/g. The BET specific surface area can be measured by a BET one point method with the use of a specific surface area analyzer.

Protective layer 13 contains the present PVdF. The weight average molecular weight (hereinafter also referred to as “Mw”) of the present PVdF is 750,000 or more, and it may be 800,000 or more, or may be 850,000 or more, or may be 870,000 or more, or may be 880,000 or more, or may be 900,000 or more, or may be 950,000 or more, or may be from 750,000 to 1,200,000, or may be from 800,000 to 1,200,000, or may be from 850,000 to 1,150,000, or may be from 870,000 to 1,120,000, or may be from 880,000 to 1,100,000, or may be from 900,000 to 1,080,000, or may be from 950,000 to 1,050,000. The weight average molecular weight Mw of the present PVdF can be measured in terms of standard polystyrene by a GPC method (gel permeation chromatography).

When the Mw of the present PVdF falls within the above-mentioned range, polymer chains of the present PVdF tend to be entangled together to form a strong three-dimensional matrix in protective layer 13. By making the inorganic oxide filler fixed in the pores of the three-dimensional matrix, it is possible to reduce aggregation of the inorganic oxide filler and thereby reduce the number of lumps formed in protective layer 13.

The present PVdF is an unmodified homopolymer. The present PVdF is a polymer that has repeating structural units (—CH₂CF₂—) derived from vinylidene difluoride (hereinafter also referred to as “VdF”). The present PVdF is an unmodified polymer, namely, a polymer in which the structural unit (—CH₂CF₂—) thereof is not modified by a functional group different from any functional groups present in the structural unit. The present PVdF can be obtained as a VdF homopolymer.

When the PVdF is a modified homopolymer or a copolymer, intermolecular interaction such as hydrogen bonding and the van der Waals forces tends to occur between a polar group of the polymer and the inorganic oxide filler which has a high polarity. It is conceivable that the intermolecular interaction tends to facilitate aggregation of the inorganic oxide filler. When the present PVdF contained in protective layer 13 is an unmodified homopolymer, the above-mentioned intermolecular interaction can be reduced and thereby aggregation of the inorganic oxide filler can be reduced, which can lead to a reduced number of lumps in protective layer 13.

The content of the present PVdF in protective layer 13 may be 13.5 weight % or more, or may be 13.7 weight % or more, or may be 13.8 weight % or more, or may be 14.0 weight % or more, or may be 14.1 weight % or more; and it is from 13.5 to 50.0 weight %, and it may be from 13.7 to 40.0 weight %, or may be from 13.8 to 30.0 weight %, or may be from 14.0 to 18.0 weight %, or may be from 14.1 to 15.0 weight %. As described below, protective layer 13 is formed by applying a slurry containing the inorganic oxide filler, the present PVdF, and a solvent, to metal layer 11. When the content of the present PVdF falls within the above-mentioned range, applicability of the slurry to metal layer 11 can be good and thereby protective layer 13 can be easily formed.

The content of the inorganic oxide filler in protective layer 13 is preferably from 40 to 99 weight %, and it may be from 45 to 98 weight %, or may be from 50 to 95 weight %, or may be from 55 to 90 weight %.

The ratio of the content of the inorganic oxide filler and the content of the PVdF in the protective layer, namely (the content of the inorganic oxide filler)/(the content of the PVdF) is preferably 5.0 or more, and it may be 5.2 or more, or may be 5.5 or more, or may be 5.7 or more, or may be from 5.0 to 6.4, or may be from 5.2 to 6.3, or may be from 5.5 to 6.2, or may be from 5.7 to 6.1. When the ratio falls within the above-mentioned range, applicability of the slurry to metal layer 11 can be good and thereby protective layer 13 can be easily formed.

In addition to the inorganic oxide filler and the PVdF, protective layer 13 may contain either a conductive carbon material or a binder other than the present PVdF, or both.

Examples of the conductive carbon material include one, two, or more selected from the group consisting of graphite (such as flake graphite), carbon black (such as acetylene black, Ketjenblack), CNTs, carbon nanohorns, graphene, and fullerene. Examples of the CNTs include those mentioned above. The conductive carbon material is preferably graphite or carbon black, more preferably carbon black. When protective layer 13 contains the conductive carbon material, the content of the conductive carbon material in protective layer 13 is from 0.05 to 10 weight %, and it may be from 0.1 to 8 weight %, or may be from 0.2 to 5 weight %, or may be from 0.3 to 4 weight %.

The binder other than the present PVdF may be a polymer compound. Examples of the polymer compound include one, two, or more selected from the group consisting of polytetrafluoroethylene (PTFE), polyimide (PI), and polyamide-imide (PAI).

The number of lumps in protective layer 13 is 0.50/cm² or less, and it may be 0.40/cm² or less, or may be 0.30/cm² or less, or may be 0.25/cm² or less, or may be 0.20/cm² or less, or may be 0.15/cm² or less, or may be 0.10/cm² or less. Protective layer 13 may contain no lumps, and the number of lumps in protective layer 13 may be, for example, 0.0001/cm² or more, or 0.001/cm² or more, or 0.01/cm² or more. Any one of the above-mentioned values of the lower limit to the number of lumps can be combined with any one of the above-mentioned values of the upper limit. A lump in protective layer 13 can protrude from the surface of protective layer 13 to form a protrusion at the surface of protective layer 13.

The number of lumps in protective layer 13 is determined by visually examining the protective layer 13 in a plan view of the present positive electrode plate 10 and counting aggregates in the examined region, as described in detail in the following. Aggregates having sizes of 0.5 mm or more in the length direction and 0.5 mm or more in the width direction which is orthogonal to the length direction are counted. Then, based on the area of the region of protective layer 13 examined in a plan view of the present positive electrode plate 10, the number of aggregates is converted into a value per unit area [cm²], which is regarded as the number of lumps in protective layer 13. The size of the examined region of protective layer 13 is 0.2 cm×10 cm or more, such as, for example, 0.4 cm×50 cm.

The number of lumps in protective layer 13 may be adjusted to fall within the above-mentioned range by reducing aggregation of the inorganic oxide filler in the slurry that is used for forming protective layer 13. Aggregation of the inorganic oxide filler may be reduced by, for example, changing the slurry preparation procedure and/or changing the viscosity, concentration, and the like of a dispersion of the present PVdF to be used for preparing the slurry, as described below in the section “Method of Producing Slurry”.

### (Method of Producing Slurry)

A slurry produced by a method of producing a slurry according to the present embodiment (hereinafter the slurry is also referred to as “the present slurry”) is a slurry for forming a protective layer of a positive electrode plate. The present slurry can be used for forming protective layer 13 of the present positive electrode plate 10, for example. Protective layer 13 can be formed by applying the present slurry to metal layer 11, drying, and the like.

The above-mentioned method of producing the present slurry comprises a step (hereinafter also referred to as “a mixing step”) of mixing an inorganic oxide filler with a dispersion (hereinafter also referred to as “a PVdF dispersion”) prepared by dispersing the present PVdF in a solvent. The present PVdF is an unmodified polymer having an Mw of 750,000 or more as mentioned above. The viscosity of the PVdF dispersion at 25 °C and at a shear rate of 100 s⁻¹ is from 0.96 to 1.45 Pa·s.

The above-mentioned method of producing the present slurry may further comprise a step (hereinafter also referred to as “a preparation step”) of preparing the PVdF dispersion by mixing the present PVdF with the solvent, and the above-mentioned mixing step may involve mixing the inorganic oxide filler with the PVdF dispersion obtained in the preparation step.

The present PVdF is a high molecular weight polymer having an Mw of 750,000 or more. Because of this, when the slurry is prepared by mixing the present PVdF with the inorganic oxide filler and the solvent without pre-mixing the present PVdF with the solvent, the present PVdF and the inorganic oxide filler are not likely to be mixed sufficiently. As a result, the inorganic oxide filler tends to be aggregated in the slurry and lumps tend to be formed in protective layer 13. In the above-mentioned method of producing the present slurry, the present PVdF and the solvent are pre-mixed in the mixing step to adjust the viscosity of the resulting PVdF dispersion to fall within the above-mentioned range before mixing the resultant with the inorganic oxide. As a result that the PVdF dispersion and the inorganic oxide filler are thus mixed and stirred together, a slurry with reduced aggregation of the inorganic oxide filler can be obtained. Consequently, protective layer 13 formed by using the present slurry tends not to contain lumps.

The present slurry contains the present PVdF, the inorganic oxide filler, and the solvent. The present slurry may further contain either a conductive carbon material or a binder other than the present PVdF, or both. In the case where the present slurry contains a conductive carbon material, it is simply required to mix the PVdF dispersion, the inorganic oxide filler, and the conductive carbon material in the mixing step. In the mixing step, the PVdF dispersion and the inorganic oxide filler may be mixed before the conductive carbon material is added thereto and mixed. In the case where the present slurry contains a binder other than the present PVdF, it is simply required to mix the inorganic oxide filler with the PVdF dispersion containing the binder other than the present PVdF.

As the present PVdF, the inorganic oxide filler, the conductive carbon material, and the binder other than the present PVdF, those described above can be used. The solvent is preferably a non-aqueous solvent, and, for example, it is N-methyl-2-pyrrolidone (NMP).

The viscosity of the PVdF dispersion used in the mixing step, at 25 °C and at a shear rate of 100 s⁻¹, is from 0.96 to 1.45 Pa·s, and it may be from 0.98 to 1.40 Pa·s, or may be from 1.00 to 1.35 Pa·s, or may be from 1.05 to 1.30 Pa·s, or may be from 1.08 to 1.25 Pa·s, or may be from 1.10 to 1.20 Pa·s. When the viscosity of the PVdF dispersion falls within the above-mentioned range, a slurry with reduced aggregation of the inorganic oxide filler can be obtained with high efficiency. The viscosity of the PVdF dispersion may be determined by obtaining a flow curve at a shear rate of 0.01 to 1000 s⁻¹ with the use of a spiral viscometer and reading the viscosity at a shear rate of 100 s⁻¹.

The concentration of the PVdF in the PVdF dispersion is preferably from 4.7 to 5.3 wt %, and it may be from 4.8 to 5.2 wt %, or may be from 4.9 to 5.1 wt %, or may be from 4.7 to 5.0 wt %, or may be from 5.0 to 5.3 wt %. When the PVdF concentration of the PVdF dispersion falls within the above-mentioned range, a slurry with reduced aggregation of the inorganic oxide filler tends to be obtained by mixing the PVdF dispersion and the inorganic oxide filler. In addition, a slurry with excellent applicability to metal layer 11 tends to be obtained.

In the mixing step, the PVdF dispersion and the inorganic oxide filler are mixed to form a mixture. The solid content of the mixture relative to the total amount of the mixture is from 10 to 40 weight %, for example, and it may be from 15 to 30 weight %, or from 15 to 25 weight %.

The content of the PVdF in the mixture relative to 100 parts by weight of solid matter (components except the solvent) is preferably from 13.5 to 50.0 weight %, and it may be from 13.7 to 40.0 weight %, or may be from 13.8 to 30.0 weight %, or may be from 14.0 to 20.0 weight %, or may be from 14.1 to 18.0 weight %, or may be from 13.5 to 15.0 weight %. The content of the inorganic oxide filler in the mixture relative to 100 parts by weight of solid matter may be from 40 to 99 weight %, or may be from 45 to 98 weight %, or may be from 50 to 95 weight %, or may be from 55 to 90 weight %. When the mixture contains a conductive carbon material, the content of the conductive carbon material in the mixture relative to 100 parts by weight of solid matter may be from 0.05 to 10 weight %, or may be from 0.1 to 8 weight %, or may be from 0.2 to 5 weight %, or may be from 0.3 to 4 weight %.

In the mixing step, the PVdF dispersion and the inorganic oxide filler are preferably mixed while being stirred with the use of a stirring apparatus. As the stirring apparatus, a known apparatus can be used without limitation, and examples thereof include a stirrer equipped with a rotating blade, a filmixer, a media agitation mill, a planetary mixer, a twin-screw kneader, and the like.

In the mixing step, a planetary mixer with 5-L capacity (HIVIS DISPER MIX Model 3D-5) may be used for mixing the PVdF dispersion with the inorganic oxide filler, for example. In this case, the stirring duration may be, for example, from 70 to 200 min, or from 80 to 180 min, or from 90 to 170 min, or from 100 to 160 min, or from 120 to 150 min. When the stirring duration falls within the above-mentioned range, aggregation of the inorganic oxide filler in the slurry tends to be reduced.

The above-mentioned method of producing the present slurry may comprise the preparation step as mentioned above, and it may comprise the preparation step before the mixing step. In the preparation step, the present PVdF and the solvent are preferably mixed while being stirred with the use of a known stirring apparatus. As the stirring apparatus, a known apparatus can be used without limitation, and, for example, an apparatus mentioned in the section describing the mixing step can be used. The stirring apparatus used in the preparation step may be the same as or different from the stirring apparatus used in the mixing step.

The average viscosity of the present slurry at 25 °C and at a shear rate of 0.1 to 10 s⁻¹ is preferably from 1.0 to 13.0 Pa·s. The average viscosity of the present slurry may be from 1.2 to 12.5 Pa·s, or from 1.5 to 12.0 Pa·s, or from 1.8 to 12.3 Pa·s, or from 2.0 to 10.0 Pa·s, or from 2.5 to 8.0 Pa·s, or from 3.0 to 6.0 Pa·s. It is regarded that the shear rate of 0.1 to 10 s⁻¹ corresponds to the shear rate during transfer of the present slurry through a pipe. When the average viscosity of the present slurry at a shear rate of 0.1 to 10 s⁻¹ falls within the above-mentioned range, clogging of a pipe tends to be reduced during transfer of the present slurry through the pipe.

The average viscosity of the present slurry at 25 °C and at a shear rate of 0.01 to 0.1 s⁻¹ is not particularly limited, and, for example, it may be from 1.0 to 16.0 Pa·s, or from 1.2 to 15.5 Pa·s, or from 1.5 to 10.0 Pa·s, or from 1.7 to 8.0 Pa·s. It is regarded that the shear rate of 0.01 to 0.1 s⁻¹ corresponds to the shear rate during storage of the present slurry. Accordingly, when the average viscosity of the present slurry at a shear rate of 0.01 to 0.1 s⁻¹ falls within the above-mentioned range, the present slurry during storage can have a proper viscosity.

The average viscosity of the present slurry at 25 °C and at a shear rate of 10 to 100 s⁻¹ is not particularly limited, and, for example, it may be from 0.5 to 5.0 Pa·s, or from 1.0 to 4.0 Pa·s, or from 1.1 to 3.0 Pa·s, or from 1.2 to 2.5 Pa·s. It is regarded that the shear rate of 10 to 100 s⁻¹ corresponds to the shear rate during application of the present slurry. Accordingly, when the average viscosity of the present slurry at a shear rate of 10 to 100 s⁻¹ falls within the above-mentioned range, the present slurry can have good applicability to the metal layer.

The average viscosity of the present slurry can be determined by obtaining a flow curve at a shear rate of 0.01 to 1000 s⁻¹ with the use of a rheometer. The average viscosity of the present slurry at 25 °C and at 0.1 to 10 s⁻¹ is determined as follows: the positions of 0.1 s⁻¹ and 10 s⁻¹ on the shear rate logarithmic axis of the flow curve are identified; the distance between these 2 positions is divided into 8 equal parts to identify 7 positions; for shear rates at these 9 positions in total, the viscosity is read; and these 9 viscosity values thus read are averaged to determine the average viscosity. The average viscosity of the present slurry at 25 °C and at a shear rate of 0.01 to 0.1 s⁻¹ and a shear rate of 10 to 100 s⁻¹ can be determined by the procedure described below in the Examples section.

The present slurry may be the mixture obtained in the mixing step. Therefore, the range of the solid content of the present slurry may be the same as the range of the solid content of the mixture. The present slurry may contain the present PVdF, the inorganic oxide filler, the conductive carbon material, and the solvent respectively in the contents mentioned in the section describing the mixture.

### (Method of Producing Positive Electrode Plate)

A method of producing a positive electrode plate (a positive electrode plate production method) according to the present embodiment is a method of producing a positive electrode plate by using the present slurry obtained by the above-mentioned method of producing the present slurry. The positive electrode plate produced by the positive electrode plate production method may be the above-mentioned present positive electrode plate.

The positive electrode plate produced by the positive electrode plate production method is a method of producing a positive electrode plate having a metal layer, an active material layer containing a positive electrode active material, and a protective layer, and the active material layer and the protective layer are formed on the metal layer and positioned adjacent to each other in a plan view of the positive electrode plate. The positive electrode plate may have the structure mentioned in the section describing the present positive electrode plate.

The positive electrode plate production method comprises applying the present slurry to the metal layer. The present slurry thus applied to the metal layer can be dried and the like to form the protective layer. The metal layer to which the present slurry is applied may be a metal layer on which an active material layer is not formed, but preferably, it is a metal layer on which an active material layer is formed.

The positive electrode plate production method may comprise a step of applying a positive electrode slurry containing a positive electrode active material that is for forming the active material layer to the metal layer. The positive electrode slurry thus applied to the metal layer is dried, compressed, and the like to form the active material layer. In the case where the present slurry is applied to the metal layer on which the active material layer is formed to form the protective layer as mentioned above, the present slurry may be applied at a position adjacent to the active material layer on the metal layer, to form the protective layer. The protective layer may be formed so as to partially cover the active material layer on the metal layer.

### (Non-Aqueous Electrolyte Secondary Battery)

A secondary battery has an electrode assembly containing the present positive electrode plate as well as a non-aqueous electrolyte, and it can further have a battery case for accommodating the electrode assembly and the non-aqueous electrolyte solution

The battery case may include an exterior package having an opening as well as a sealing plate for sealing the opening. Each of the exterior package and the sealing plate is preferably made of metal, and can be formed by using aluminum, aluminum alloy, iron, iron alloy, or the like. Between the electrode assembly and the exterior package, a resin sheet may be provided as an electrode holder. Alternatively, the battery case may be made of a laminated film. The laminated film has a multilayer structure formed of a metal layer and a resin layer stacked on top of one another, for example. The edges of the laminated film can be stacked and fused together to form a pouch-shaped battery case.

The electrode assembly may include the present positive electrode plate, a negative electrode plate, and a separator. In the electrode assembly, the active material layer of the present positive electrode plate faces a negative electrode active material layer of the negative electrode plate, with the separator interposed therebetween. The electrode assembly may be a stack-type one that is formed by stacking the present positive electrode plate, the negative electrode plate, and the separator, or may be a wound-type one that is formed by stacking the present positive electrode plate, the negative electrode plate, and the separator and winding the resulting stack. After the stack is wound, the wound-type electrode assembly may be pressed into a flat shape. In the secondary battery, a bundle of electrode tabs of the present positive electrode plate is connected to a positive electrode terminal, and a bundle of electrode tabs of the negative electrode plate is connected to a negative electrode terminal.

The separator has a base material, and on at least one side of the base material, it may have a functional layer. Examples of the functional layer include an adhesive layer and a heat-resistant layer, for example, and the functional layer can be either one of them or both. The separator and the functional layer can be formed with known materials. The non-aqueous electrolyte solution is preferably obtained by adding an electrolyte to a non-aqueous solvent such as an organic solvent. As the electrolyte, a known material can be used.

### EXAMPLES

In the following, the present disclosure will be described in further detail by way of Test Examples.

### [Preparation of Sample]

### (Preparation of Inorganic Oxide Filler)

As an inorganic oxide filler, alumina (with an average particle size (D50) of 0.67 μm, and a BET specific surface area of 4.2 m²/g) was prepared.

### (Preparation of Polyvinylidene Difluoride (PVdF))

PVdFs (1) to (4) specified in Table 1 were prepared.

TABLE 1

| | | Weight average molecular |
|---|---|---|
| | Type of polymer | weight, Mw |
| PVdF (1) | Unmodified homopolymer | 1,000,000 |
| PVdF (2) | Modified polymer | 880,000 |
| PVdF (3) | Unmodified homopolymer | 670,000~700,000 |
| PVdF (4) | Modified polymer | 1,000,000~1,200,000 |

### (Preparation of Conductive Carbon Material)

As a conductive carbon material, acetylene black (hereinafter also referred to as “AB”) was prepared.

### (Preparation of Solvent)

As a solvent, N-methyl-2-pyrrolidone (NMP) was prepared.

### Test Example 12

The PVdF (1) and NMP were mixed and stirred to prepare a PVdF dispersion having a concentration of the PVdF (1) of 5.0 weight % (a preparation step). While the PVdF dispersion was being stirred, alumina was added thereto in 4 equal parts, in the ratio specified in Table 3. To the PVdF dispersion to which the entire amount of alumina was added, NMP was added and stirred, followed by addition of AB and NMP and further stirring to obtain a mixture (a mixing step), and the resulting mixture was used as a slurry. In the preparation step and the mixing step, the components were mixed with the use of a planetary mixer with 5-L capacity (HIVIS DISPER MIX Model 3D-5), and in the mixing step, the stirring duration with the use of the planetary mixer was 150 min. The weight ratio of the components in the mixture (slurry) was alumina:PVdF:AB=85.33:14.23:0.44, and alumina/PVdF=6.0.

### Test Examples 1, 5, 6, 8, 13, and 14

Except that the PVdF specified in Table 2 and Table 3 was used and a PVdF dispersion having the PVdF concentration specified in Table 2 and Table 3 was prepared, the same procedure as in the preparation step in Test Example 12 was implemented to prepare a PVdF dispersion.

Except that the PVdF dispersion prepared in the preparation step was used and the weight ratio of the components in the mixture (slurry) and the stirring duration were set as specified in Table 2 and Table 3, the same procedure as in the mixing step in Test Example 12 was implemented to obtain a mixture (slurry).

### Test Example 9

A PVdF dispersion was not prepared, and instead, alumina was added in 4 equal parts while the PVdF (1) was being stirred. To the PVdF (1) to which the entire amount of alumina was added, NMP was added and stirred, followed by addition of AB and NMP and further stirring to obtain a mixture, and the resulting mixture was used as a slurry. At the time of preparation of the mixture, the components were mixed with the use of a planetary mixer with 5-L capacity (HIVIS DISPER MIX Model 3D-5), and the stirring duration until the mixture was obtained with the use of the PVdF (1) to which the entire amount of alumina was added was 200 min.

### Test Examples 2 to 4, 7, 10, 11

Except that the PVdF specified in Table 2 and Table 3 was used and a PVdF dispersion having the PVdF concentration specified in Table 2 and Table 3 was prepared, the same procedure as in the preparation step in Test Example 12 was implemented to prepare a PVdF dispersion. The viscosity of the PVdF dispersion obtained in Test Examples 2 to 4, 7, 10, 11 was measured by a procedure described below, and it was found that the PVdF dispersion obtained in Test Examples 2, 7, and 11 had high viscosity; thereby it was conjectured that if a slurry was prepared by mixing alumina, the PVdF dispersion, and AB in a similar blending ratio to Test Example 12, more than 0.50 lumps per 1 cm² would be formed in the protective layer. In contrast, the PVdF dispersion obtained in Test Examples 3, 4, and 10 had low viscosity, and thereby it was conjectured that if a slurry was prepared by mixing alumina, the PVdF dispersion, and AB in a similar blending ratio to Test Example 12, applicability of the resulting slurry to the metal layer for forming a protective layer would be poor and alumina tends not to be bound, and thereby a good protective layer tends not to be formed. It should be noted that the content of each component of the slurry specified in Table 3 as for Test Examples 10 and 11 is the content of the component based on the assumption that the slurry was prepared by mixing alumina, the PVdF dispersion, and AB in a similar blending ratio to Test Example 12 to form a protective layer.

### [Determination of Viscosity of PVdF Dispersion]

With a spiral viscometer, at a temperature of 25 °C, with the shear rate applied to the PVdF dispersion prepared in Test Example being changed from 0.01 to 1000 s⁻¹, a flow curve was obtained. On the resulting flow curve, the viscosity at a shear rate of 100 s⁻¹ was read. Results are given in Table 2 and Table 3.

### [Determination of Average Viscosity of Slurry]

With a rheometer, with the shear rate applied to the slurry obtained in Test Example being changed from 0.01 to 1000 s⁻¹, a flow curve was obtained in which the horizontal axis was a logarithmic axis representing the shear rate and the vertical axis was a linear axis representing the viscosity.

(Average Viscosity of Slurry at Shear Rate of 0.01 to 0.1 s⁻¹)

The positions of 0.01 s⁻¹ and 0.1 s⁻¹ on the horizontal axis of the flow curve were identified; the distance between these 2 positions was divided into 4 equal parts to identify 3 positions; and for shear rates at these 5 positions in total, the viscosity was read. These 5 viscosity values thus read were averaged to calculate the average viscosity of the slurry at a shear rate of 0.01 to 0.1 s⁻¹. Results are given in Table 2 and Table 3.

(Average Viscosity of Slurry at Shear Rate of 0.1 to 10 s⁻¹)

The positions of 0.1 s⁻¹ and 10 s⁻¹ on the horizontal axis of the flow curve were identified; the distance between these 2 positions was divided into 8 equal parts to identify 7 positions; and for shear rates at these 9 positions in total, the viscosity was read. These 9 viscosity values thus read were averaged to calculate the average viscosity of the slurry at a shear rate of 0.1 to 10 s⁻¹. Results are given in Table 2 and

### Table 3.

(Average Viscosity of Slurry at Shear Rate of 10 to 100 s⁻¹)

The positions of 10 s⁻¹ and 100 s⁻¹ on the horizontal axis of the flow curve were identified; the distance between these 2 positions was divided into 4 equal parts to identify 3 positions; and for shear rates at these 5 positions in total, the viscosity was read. These 5 viscosity values thus read were averaged to calculate the average viscosity of the slurry at a shear rate of 10 to 100 s⁻¹. Results are given in Table 2 and Table 3.

### [Counting Lumps in Protective Layer]

On a glass plate, a PET (polyethylene terephthalate) film was placed. To the PET film, the slurry obtained in Test Example was applied with the use of an applicator in a coating thickness of 125 μm. The glass plate with the PET film to which the slurry was applied was placed on a hot plate and heated and dried at 100 °C for 10 minutes to form a protective layer on the PET film. The protective layer was cut into a 3×8-cm square, and by visual examination, aggregates having sizes of 0.5 mm or more in the length direction and 0.5 mm or more in the width direction which was orthogonal to the length direction were counted. The number of these aggregates was converted into a value per unit area, and the resultant was regarded as the number of lumps. Results are given in Table 2 and Table 3.

TABLE 2

| | Test Example | | | | | | |
|---|---|---|---|---|---|---|---|
| | 3 | 2 | 3 | 4 | 5 | 6 | 7 |
| | Comp. | (Comp.) | (Comp.) | (Comp.) | Comp. | Comp. | (Comp.) |
| Type of PVdF | (2) | (2) | (2) | (3) | (3) | (3) | (3) |
| PVdF Dispersion | | | | | | | |
| PVdF Concentration [wt %] | 6.3 | 8.0 | 5.0 | 5.0 | 7.3 | 7.3 | 10 |
| Viscosity [Pa · s] | 1.17 | 2.32 | 0.49 | 0.27 | 1.03 | 1.03 | 2.73 |
| Mixing step | | | | | | | |
| Stirring duration [min] | 150 | — | — | — | 150 | 60 | — |
| Slurry | | | | | | | |
| Composition (solid matter) | | | | | | | |
| Al₂O₃ [weight %]* | 82.28 | — | — | — | 80.09 | 80.09 | — |
| PVdF [weight %]* | 17.30 | — | — | — | 19.50 | 19.50 | — |
| AB [weight %]* | 0.42 | — | — | — | 0.41 | 0.41 | — |
| Ratio (Al₂O₃/PVdF) | 4.8 | — | — | — | 4.1 | 4.1 | — |
| Average viscosity [Pa · s] | | | | | | | |
| Viscosity at 0.01 to 0.1 s^{-l} | 1.96 | — | — | — | 3.35 | 2.82 | — |
| Viscosity at 0.1 to 10 s^{-l} | 1.74 | — | — | — | 3.00 | 2.53 | — |
| Viscosity at 10 to 100 s^{-l} | 1.37 | — | — | — | 1.28 | 1.42 | — |
| Protective layer | | | | | | | |
| Number of lumps [per 1 cm²] | 1.9 | — | — | — | 3.0 | >100 | — |

*Weight ratio relative to 100 weight % of solid matter

TABLE 3

| | Test Example | | | | | | |
|---|---|---|---|---|---|---|---|
| | 8 | 9 | 10 | 11 | | | |
| | Comp. | Comp. | (Comp.) | (Comp.) | 12 | 13 | 14 |
| Type of PVdF | (4) | (1) | (1) | (1) | (1) | (1) | (1) |
| PVdF Dispersion | | | | | | | |
| PVdF Concentration [wt %] | 6.5 | — | 4.6 | 5.4 | 5.0 | 5.0 | 5.0 |
| Viscosity [Pa · s] | 1.33 | — | 0.95 | 1.46 | 1.16 | 1.16 | 1.16 |
| Mixing step | | | | | | | |
| Stirring duration [min] | 150 | (200) | — | — | 90 | 120 | 150 |
| Slurry | | | | | | | |
| Composition (solid matter) | | | | | | | |
| Al₂O₃ [weight %]* | 81.83 | 83.00 | (86.31) | (84.37) | 85.33 | 85.33 | 85.33 |
| PVdF [weight %]* | 17.75 | 14.00 | (13.25) | (15.20) | 14.23 | 14.23 | 14.23 |
| AB [weight %]* | 0.42 | 3.00 | (0.44) | (0.43) | 0.44 | 0.44 | 0.44 |
| Ratio (Al₂O₃/PVdF) | 4.6 | 5.9 | (6.5) | (5.6) | 6.0 | 6.0 | 6.0 |
| Average viscosity [Pa · s] | | | | | | | |
| Viscosity at 0.01 to 0.1 s^{-l} | 2.01 | 1.75 | — | — | 15.12 | 9.56 | 1.94 |
| Viscosity at 0.1 to 10 s^{-l} | 1.86 | 1.62 | — | — | 12.30 | 4.78 | 1.80 |
| Viscosity at 10 to 100 s^{-l} | 1.45 | 1.17 | — | — | 2.23 | 2.08 | 1.30 |
| Protective layer | | | | | | | |
| Number of lumps [per 1 cm²] | 100 | >100 | — | — | 0.12 | 0.21 | 0.042 |

*Weight ratio relative to 100 weight % of solid matter

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate comprising:
a metal layer;
an active material layer containing a positive electrode active material; and
a protective layer, wherein
the active material layer and the protective layer are formed on the metal layer and positioned adjacent to each other in a plan view of the positive electrode plate,
the protective layer contains an inorganic oxide filler and polyvinylidene difluoride,
the polyvinylidene difluoride is an unmodified homopolymer having a weight average molecular weight of 750,000 or more, and a content of the polyvinylidene difluoride in the protective layer is 13.5 weight % or more, and
the number of lumps in the protective layer is 0.50/cm² or less.

2. The positive electrode plate according to claim 1, wherein a content of the inorganic oxide filler in the protective layer is from 40 to 99 weight %.

3. The positive electrode plate according to claim 1, wherein a ratio of a content of the inorganic oxide filler and the content of the polyvinylidene difluoride ((the content of the inorganic oxide filler)/(the content of the polyvinylidene difluoride)) in the protective layer is 5.0 or more.

4. The positive electrode plate according to claim 1, wherein the protective layer further contains a conductive carbon material.

5. The positive electrode plate according to claim 1, wherein the inorganic oxide filler is alumina.

6. A method of producing a slurry that is for forming a protective layer of a positive electrode plate, the method comprising:
mixing an inorganic oxide filler with a dispersion prepared by dispersing polyvinylidene difluoride in a solvent, wherein
the polyvinylidene difluoride is an unmodified homopolymer having a weight average molecular weight of 750,000 or more, and
a viscosity of the dispersion at 25 °C and at a shear rate of 100 s⁻¹ is from 0.96 to 1.45 Pa·s.

7. The method of producing a slurry according to claim 6, further comprising preparing the dispersion by mixing the polyvinylidene difluoride with the solvent, where
the mixing according to claim 6 involves mixing the inorganic oxide filler with the dispersion obtained by the preparing.

8. The method of producing a slurry according to claim 6, wherein the mixing according to claim 6 involves further adding a conductive carbon material and mixing together.

9. The method of producing a slurry according to claim 6, wherein an average viscosity of the slurry at 25 °C and at a shear rate of 0.1 to 10 s⁻¹ is from 1.0 to 13.0 Pa·s.

10. The method of producing a slurry according to claim 6, wherein the dispersion contains the polyvinylidene difluoride in a concentration of 4.7 to 5.3 wt %.

11. A method of producing a positive electrode plate having a metal layer, an active material layer containing a positive electrode active material, and a protective layer, wherein
the active material layer and the protective layer are formed on the metal layer and positioned adjacent to each other in a plan view of the positive electrode plate, and
the method includes applying a slurry produced by the method of producing a slurry according to claim 6 to the metal layer.
